(19) United States
(12) Patent Application Publication
(10) Pub. No.: US 2023/0048985 A1
(43) Pub. Date: Feb. 16, 2023

(54) STATOR, ROTOR, AND ROTATING ELECTRICAL MACHINE

(71) Applicant: FANUC CORPORATION, Yamanashi (JP)

(72) Inventor: Yasuo YAMADA, Yamanashi (JP)

(73) Assignee: FANUC CORPORATION, Yamanashi (JP)

(21) Appl. No.: 17/758,274

(22) PCT Filed: Mar. 30, 2021
(86) PCT No.: PCT/JP2021/013536

§ 371 Date: Jun. 30, 2022

(30) Foreign Application Priority Data
Apr. 1, 2020 (JP) 2020-065931

(51) Int. Cl. H02K 1/14; H02K 1/18

(52) U.S. Cl. CPC H02K 1/148; H02K 1/185

(57) ABSTRACT

Provide are a stator, a rotor, and a rotating electrical machine that reduce cogging or ripple due to a gap between core divided sections. The stator comprises a plurality of core divided sections each having a cutout part extending along an. axial direction, and a plurality of pins provided for each of the core divisions adjacent to each. other and press- fit into pin press-fit holes formed by the cutout parts facing each. other. The plurality of core divided. sections are divided from each other at division surfaces each consisting of four or more constituent surfaces extending along the axial direction, the constituent surfaces including the three surfaces of a first surface closest to a magnetic gap part, a second surface second closest to the magnetic gap part after the first surface, and a farthest surface farthest from. the magnetic gap part. A pin press-fit surface that is one of the constituent surfaces other than the first surface and the second surface and provided with the cutout part has a normal direction oriented in an out-of-plane direction of the first surface or an out-of-plane direction of the second surface.

### BACKGROUND OF THE INVENTION

Technical Field

The present invention relates to a stator, a rotor and a rotating electrical machine.

Background Art

Japanese Unexamined Patent Application, Publication No. 2012-165512 describes “a rotating electrical machine comprising a stator, the stator being configured with a plurality, of plate-shaped stator cores, each of the stator cores being configured with a ring-shaped fixing portion and teeth portions, each of the teeth portions being formed in a T-shape by a leg piece and a teeth piece, wherein a configuration is made in which base ends of the leg pieces of the teeth portions are fit in and integrated with a plurality of concave grooves that are concavely provided on the fixing portion, notches that become circular-shaped by being fit at arbitrary positions on a fitting portion between the fixing portion and the teeth portions are formed, and the fixing portion and the teeth portions are integrated by press- fitting, into notches that become communicating cylindrical holes by laminating and fitting a plurality of fixing portions and a plurality of teeth portions, fixing pins with an outer diameter slightly larger than the cylindrical holes”.

Patent Document 1: Japanese Unexamined Patent Application, Publication. No.2012-165512

### SUMMARY OF THE INVENTION

Problems to be Solved by the Invention

However, there is a possibility that a gap occurs on surfaces (a magnetic path) of the fitting portions between the fixing portions and the teeth portions (a plurality of core splits) on a side where the fixing pins are press-fit. In the rotating electrical machine provided with a stator in which such a gap has occurred, cogging or ripple occurs, and properties deteriorate. Such a problem can also occur in a rotor that is similarly configured.

The present invention provides a stator, a rotor and a rotating electrical machine that can reduce cogging or ripple due to a gap between core splits.

Means for Solving the Problems

An aspect of the present disclosure is a stator comprising a plurality of core splits, each of the core splits having a notched portion extending along an axial direction, and a plurality of pins press-fit in pin press-fit holes, each of the pin press-fit holes being formed by notched portions provided on adjoining core splits and facing each other, wherein the plurality of core splits are mutually split by split surfaces, each of the split surfaces being configured with four or more constituent faces extending along the axial direction, the constituent faces including three faces of a first face closest to a magnetic gap portion, a second face next closest to the magnetic gap portion after the first face, and a farthest face farthest from the magnetic gap portion, and a pin press-fit surface that is one of the constituent faces other than the first face and the second face and provided with the notched portion has a normal direction oriented in an out-of-plane direction of the first face or an out-of-plane direction of the second face.

Further, an aspect of the present disclosure is a rotor comprising a plurality of core splits, each of the core splits having a notched portion extending along an axial direction, and a plurality of pins press-fit in pin press-fit holes, each of the pin press-fit holes being formed by notched portions provided on adjoining core splits and facing each other, wherein the plurality of core splits are mutually split by split surfaces, each of the split surfaces being configured with four or more constituent faces extending along the axial direction, the constituent faces including three faces of a first face closest to a magnetic gap portion, a second face next closest to the magnetic gap portion after the first face, and a farthest face farthest from the magnetic gap portion, and a pin press-fit surface that is one of the constituent faces other than the first face and the second face and provided with the notched portion has a normal direction oriented in an out-of-plane direction of the first face or an out-of-plane direction of the second face.

Effects of the Invention

According to an aspect of the present disclosure, it is possible to reduce cogging or ripple due to a gap between core splits.

### BRIEF DESCRIPTION OF THE DRAWINGS

FIG. 1 is a cross-sectional view showing a part of a stator according to a first embodiment;

FIG. 2 is a schematic diagram describing normal directions of a pin press-fit surface of the stator shown in FIG. 1;

FIG. 3 is a cross-sectional view showing a part of a rotor according to a second embodiment;

FIG. 4 is a schematic diagram describing normal directions of a pin press-fit surface of the rotor shown in FIG. 3;

FIG. 5 is a cross-sectional view showing a part of a stator according to a third embodiment;

FIG. 6 is a schematic diagram describing normal directions of a pin press-fit surface of the stator shown in FIG. 5;

FIG. 7 is a cross-sectional view showing a part of a stator according to a fourth embodiment; FIG. 8 is a schematic diagram describing normal directions of a pin press-fit surface of the stator shown in FIG. 7; FIG. 9A is a diagram for describing the number of constituent faces constituting each split surface and is an exploded cross-sectional view showing a part of a stator; FIG. 9B is an exploded cross-sectional view showing a part of a stator equivalent to the stator shown in FIG. 9A; FIG. 10A is an exploded cross-sectional view showing a part of another stator, which describes the number of constituent faces constituting each split surface; and FIG. 10B is an exploded cross-sectional view showing a part of a stator equivalent to the stator shown in FIG. 10A.

PREFERRED MODE FOR CARRYING OUT THE INVENTION

Stators 1, 3, and 4, a rotor 2 and an electric motor (reference sign omitted.) according to embodiments will be described below with reference to drawings.

[First embodiment]

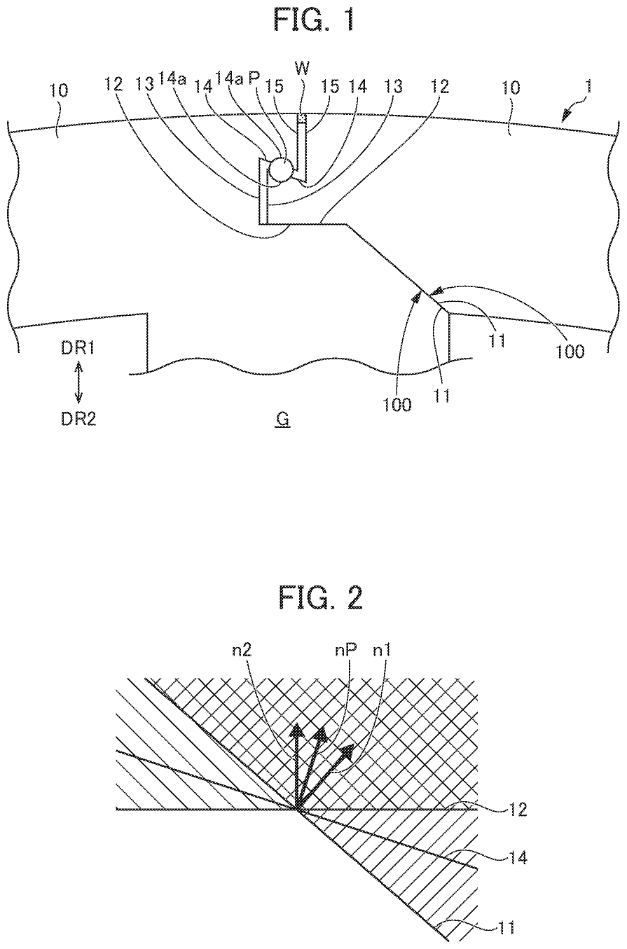

First, confgurations of a stator 1 and. an electric motor (reference sign omitted) according to a first embodiment will be described using FIG. 1. FIG. 1 is a cross-sectional diagram showing a part of the stator 1.

The stator 1 shown in FIG. 1 constitutes the electric motor (reference sign omitted) as a rotating electrical machine, together with a rotor (not shown) arranged on a radial-direction inner side DR2 of the stator 1 (the lower side in FIG. 1). Specifically, the stator 1 is provided with a plurality of core splits 10, a plurality of pins P, a plurality of coils (not shown.), and the like.

The plurality of core splits 10 are mutually split by split surfaces 100 extending along the axial direction (a direction penetrating the page of FIG. 1) and facing each other. The plurality of core splits 10 have a structure of being fit by being mutually slid in the axial direction.

Each split surface 100 is configured with five constituent faces 11, 12, 13, 14, and 15 extending along the axial direction. In adjoining core splits 10 and 10, the split surface 100 and each of the constituent faces 11 to 15 are given the same reference signs. The first face 11, which is a first constituent face, is closest to a magnetic gap portion G (on the radial-direction inner side DR2) which is a gap between the stator 1 and the rotor (not shown). The second face 12, which is a second constituent face, is a face continuous with the first face 11 and is next closest to the magnetic gap portion G after the first face 11. The third face 13, which is a third constituent face, is a face continuous with the second face 12 and is next closest to the magnetic gap portion G after the second face 12.

The fourth face 14, which is a fourth constituent face, is a face continuous with the third face 13 and is next closest to the magnetic gap portion G after the third face 13. This fourth face 14 constitutes a pin press-fit surface where a notched portion 14a with an approximately semicircular- shaped section extending along the axial direction is provided. The notched portions 14a provided on adjoining core splits 10 and facing each other constitute a pin press-fit hole with an approximately circular-shaped (unclosed circular- shaped) section extending along the axial direction. The fifth face 15, which is a fifth constituent face, is a face continuous with the fourth face 14 and constitutes “the farthest face” farthest from the magnetic gap portion G.

Between adjoining core splits 10, the facing fifth faces (the farthest faces) 15 are fixed by welding W.

Each of the plurality of pins P is press-fit in a pin press-fit hole. The pin press-fit hole is formed by the notched portions 14a provided on adjoining core splits 10 and facing each other.

Next, a direction nP of the normal of the fourth face (the pin press-fit surface) 14 of The stator 1 will be described using FIG. 2. FIG. 2 is a schematic diagram describing the direction nP of the normal of the fourth face (the pin press-fit surface) 14 of the stator 1.

FIG. 2 is a schematic diagram in which the first face 11, the second face 12, and the fourth face (the pin press-fit surface) 14 are displayed being virtually overlapped with one another. In FIG. 2, out-of-plane directions of the first face 11 are indicated by first hatching (hatching by oblique lines from the upper right to the lower left), and the normal direction of the first face 11 is indicated by an arrow n1. Out-of-plane directions of the second face 12 are indicated by second hatching (hatching by oblique lines from the upper left to the lower right), and the normal direction of the second face 12 is indicated by an arrow n2. Further, the normal direction of the fourth face (the pin press-fit surface) 14 is indicated by an arrow nP. Directions that are the out-of-plane directions of the first face 11 and. are also the out-of-plane directions of the second face 12 are indicated by hatching obtained by overlapping both of the first hatching and the second hatching (cross hatching).

As shown in FIG. 2, the direction nP of the normal of the fourth face (the pin press-fit surface) 14 is oriented in the out-of-plane direction of the first face 11 and is also oriented in the out-of-plane direction of the second face 12. Further, the direction nP of the normal of the fourth face (the pin press-fit surface) 14 is oriented in a direction between the direction n1 of the normal of the first face 11 and the direction n2 of the normal of the second face 12.

Thus, the plurality of core splits 10 are mutually split by the split surfaces 100 each of which is configured with the four or more constituent faces 11, 12, 13, 14, and 15 extending along the axial direction, including three faces of the first face 11 closest to the magnetic gap portion G, the second face 12 next closest to the magnetic gap portion G after the first face 11, and the fifth face (the farthest face) 15 farthest from the magnetic gap portion G. The fourth face (the pin press-fit surface) 14 is one of constituent faces other than the first face 11 and the second face 12 and is a face the normal direction nP of which is oriented in the out-of-plane direction of the first face 11 or the out-of- plane direction of the second. face 12. The plurality of pins P are press-fit in pin press-fit holes, each of which is formed by the notched portions 14a provided on adjoining core splits 10 and facing each other.

According to the stator 1 as above, even if the facing fourth faces 14 are split, and the facing third faces 13 and/or the facing fifth faces 15 are split, it is possible to cause the first faces 11 or the second faces 12 of adjoining core splits 10, which are close from the magnetic gap portion G, to be in close contact with each other, because the direction nP of the normal of the fourth face (the pin press- fit surface) 14 is oriented in the out-of-plane direction of the first face 11 or the out-of-plane direction of the second face 12. Thereby, it is possible to reduce cogging or ripple due to a gap between core splits 10. Further, it is possible to accurately assemble the core splits 10.

Further, in the stator 1, it is favorable that the fourth face (the pin press-fit surface) 14 is a constituent face other than the fifth face (the farthest face) 15, and that the direction nP of the normal is oriented in the direction between the direction n1 of the normal of the first face 11 and the direction n2 of the normal of the second face 12.

According to the stator 1 as above, since the direction nP of the normal of the fourth face (the pin press-fit surface) 14 is oriented in the direction between the direction n1 of the normal of the first face 11 and the direction n2 of the normal of the second face 12, it is possible to cause the mutual first faces 11 and the mutual second faces 12 of adjoining core splits 10, which are close from the magnetic gap portion G, to be in close contact with each other. Thereby, it is possible to further reduce cogging or ripple due to a gap between core splits 10. Further, it is possible to more accurately assemble the core splits 10.

Further, it is favorable that, between adjoining core splits 10 of the stator 1, the facing fifth faces (the farthest faces) 15 are fixed by the welding W.

According to the stator 1 as above, since the facing fifth faces (the farthest faces) 15 of adjoining core splits 10 are fixed by the welding W, it is possible to increase stiffness.

[Second embodiment]

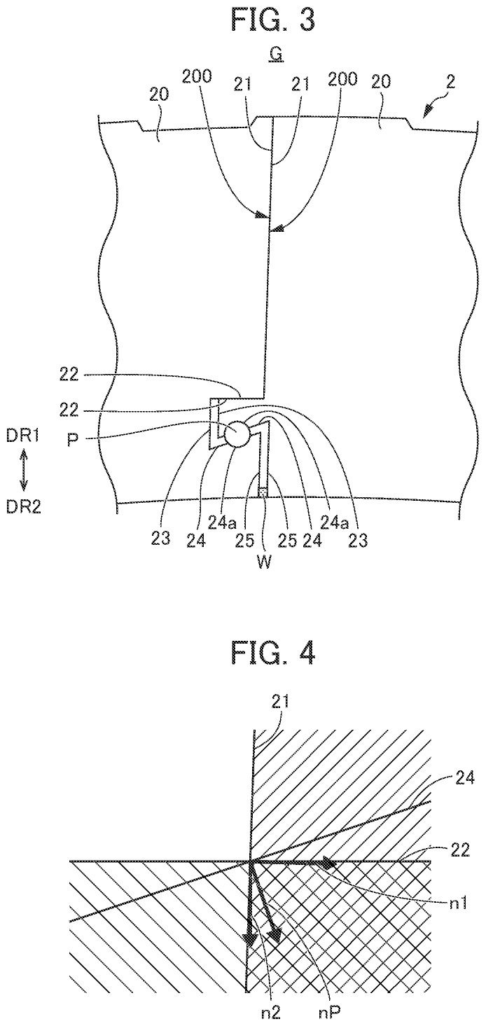

Next, configurations of a rotor 2 and an electric motor (reference sign omitted) according to a second embodiment will be described using FIG. 3. FIG. 3 is a cross-sectional diagram showing a part of the rotor 2.

The rotor 2 shown in FIG. 3 constitutes the electric motor (reference sign omitted) together with a stator (not shown) arranged on a radial-direction outer side DR1 of the rotor 2 (the upper side in FIG. 3). Specifically, the rotor 2 is provided with a plurality of core splits 20, a plurality of pins P, a plurality of permanent magnets (not shown), and the like.

The plurality of core splits 20 are split by split surfaces 200 extending along the axial direction (a direction penetrating the page of FIG. 3) and facing each other. The plurality of core splits 20 have a structure of being fit by being mutually slid in the axial direction.

Each split surface 200 is configured with five constituent faces 21, 22, 23, 24, and 25 extending along the axial direction. The first face 21, which is a first constituent face, is closest to a magnetic gap portion G (on a radial-direction inner side DR2) which is a gap between the rotor 2 and the stator (not shown). The second face 22, which is a second constituent face, is a face continuous with the first face 21 and is next closest to the magnetic gap portion G after the first face 21. The third face 23, which is a third constituent face, is a face continuous with the second face 22 and is next closest to the magnetic gap portion G after the second face 22.

The fourth face 24, which is a fourth constituent face, is a face continuous with the third face 23 and is next closest to the magnetic gap portion G after the third face 23. This fourth face 24 constitutes a pin press-fit surface where a notched portion 24a with an approximately semicircular- shaped section extending along the axial direction is provided. The notched portions 24a provided on adjoining core splits 20 and facing each other constitute a pin press-fit hole with an approximately circular-shaped (unclosed circular- shaped) section extending along the axial directon. The fifth face 25, which is a fifth constituent face, is a face continuous with the fourth face 24 and constitutes “the farthest face” farthest from the magnetic gap portion G.

Each of the plurality of pins P is press-fit in a pin press-fit hole. The pin press-fit hole is formed by the notched portions 24a provided on adjoining core splits 20 and facing each other.

Next, a direction nP of the normal of the fourth face (the pin press-fit surface) 24 of the rotor 2 be described using FIG. 4. FIG. 4 is a schematic diagram describing the direction nP of the normal of the fourth face (the pin press-fit surface) 24 of the rotor 2.

FIG. 4 is a schematic diagram in which the first face 21, the second face 22, and the fourth face (the pin press-fit surface) 24 are displayed being virtually overlapped with one another. In FIG. 4, out-of-plane directions of the first face 21 are indicated by first hatching (hatching by oblique lines from the upper right to the lower left), and the normal direction of the first face 21 is indicated by an arrow n1. Out-of-plane directions of the second face 22 are indicated by second hatching (hatching by oblique lines from the upper left to the lower right), and the normal direction of the second face 22 is indicated by an arrow n2. Further, the normal direction of the fourth face (the pin press-fit surface) 24 is indicated by an arrow nP. Directions that are the out-of-plane directions of the first face 21 and are also the out-of-plane directions of the second face 22 are indicated by hatching obtained by overlapping both of the first hatching and the second hatching (cross hatching).

As shown in FIG. 4, the direction nP of the normal of the fourth face (the pin press-fit surface) 24 is oriented in the out-of-plane direction of the first face 21 and is also oriented in the out-of-plane direction of the second face 22. Further, the direction nP of the normal of the fourth face (the pin press-fit surface) 24 is oriented in a direction between the direction n1 of the normal of the first face 21 and the direction n2 of the normal of the second face 22.

Thus, the plurality of core splits 20 are mutually split by the split surfaces 200 each of which is configured with the four or more constituent faces 21, 22, 23, 24, and 25 extending along the axial direction, including three faces of the first face 21 closest to the magnetic gap portion G, the second face 22 next closest to the magnetic gap portion G after the first face 21, and the fifth face (the farthest face) 25 farthest from the magnetic gap portion G. The fourth face (the pin press-fit surface) 24 is one of constituent faces other than the first face 21 and the second face 22 and is a face the normal direction nP of which is oriented in the out-of-plane direction of the first face 21 or the out-of- plane direction of the second face 22. The plurality of pins P are press-fit in pin press-fit holes, each of which is formed by the notched portions 24a provided on adjoining core splits 20 and facing each other.

According to the rotor 2 as above, since the direction nP of the normal of the fourth face (the pin press-fit surface) 24 is oriented in the out-of-plane direction of the first face 21 or the out-of-plane direction of the second face 22, it is possible to cause the first faces 21 or the second faces 22 of adjoining core splits 20, which are close from the magnetic gap portion G, to be in close contact with each other. Thereby, it is possible to reduce cogging or ripple due to a gap between core splits 20. Further, it is possible to accurately assemble the core splits 20.

Further, in the rotor 2, it is favorable that the fourth face (the pin press-fit surface) 24 is a constituent face other than the fifth face (the farthest face) 25, and that the direction nP of the normal is oriented in the direction between the direction n1 of the normal of the first face 21 and the direction n2 of the normal of the second face 22.

According to the rotor 2 as above, since the direction nP of the normal of the fourth face (the pin press-fit surface) 24 is oriented in the direction between the direction n1 of the normal of the first face 21 and the direction n2 of the normal of the second face 22, it is possible to cause the mutual first faces 21 and the mutual second faces 22 of mutually adjoining core splits 20, which are close from the magnetic gap portion G, to be in close contact with each other. Thereby, it is possible to further reduce cogging or ripple due to a gap between core splits 20. Further, it is possible to more accurately assemble the core splits 20.

[Third. embodiment]

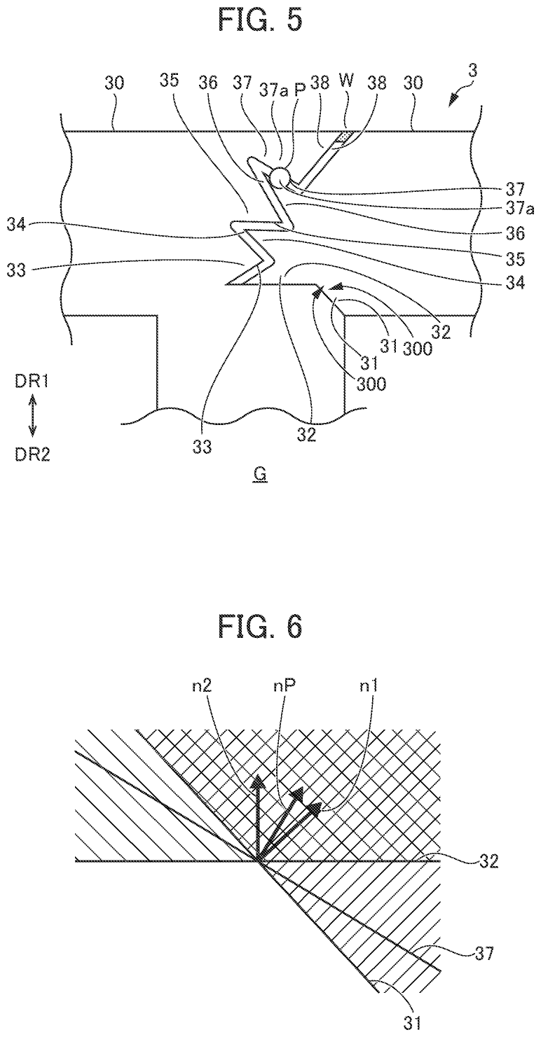

Next, configurations of a stator 3 and an electric motor (reference sign omitted) according to a third embodiment will be described using FIG. 5. FIG. 5 is a. cross-sectional diagram showing a part of the stator 3.

The stator 3 shown in FIG. 5 constitutes the electric motor (reference sign omitted) together with a rotor (not shown) arranged on a radial-direction inner side DR2 of the stator 3 (the lower side in FIG. 5). Specifically, the stator 3 is provided with a plurality of core splits 30, a plurality of pins P, a plurality of coils (not shown), and the like.

The plurality of core splits 30 are mutually split by split surfaces 300 extending along the axial direction (a direction penetrating the page of FIG. 5) and facing each other. The plurality of core splits 30 have a structure of being fit by being mutually slid in the axial direction.

Each split surface 300 is configured with eight constituent faces 31, 32, 33, 34, 35, 36, 37, and 38 extending along the axial direction. The first face 31, which is a first constituent face, is closest to a magnetic gap portion G (on the radial-direction inner side DR2) which is a gap between the stator 3 and the rotor (not shown). The second face 32, which is a second constituent face, is a face continuous with the first face 31 and is next closest to the magnetic gap portion G after the first face 31. The third face 33, which is a third constituent face, is a face continuous with the second face 32 and is next closest to the magnetic gap portion G after the second face 32. The fourth face 34, which is a fourth constituent face, is a face continuous with the third face 33 and is next closest to the magnetic gap portion G after the third face 33.

The fifth face 35, which is a fifth constituent face, is a face continuous with the fourth face 34 and is next closest to the magnetic gap portion G after the fourth face 34. The sixth face 36, which is a sixth constituent face, is next closest to the magnetic gap portion G after the fifth face 35. The seventh face 37, which is a seventh constituent face, is next closest to the magnetic gap portion G after the sixth face 36. This seventh face constitutes a pin press-fit surface where a notched portion 37a with an approximately semicircular-shaped section extending along the axial direction is provided. The notched portions 37a provided on adjoining core splits 30 and facing each other constitute a pin press-fit hole with an approximately circuiar-shaped (unclosed circular-shaped) section extending along the axial direction. The eighth face 38, which is an eighth constituent face, is a face continuous with the seventh face 37 and constitutes “the farthest face” farthest from the magnetic gap portion G.

Between adjoining core splits 30, the facing eighth faces (the farthest faces) 38 are fixed by welding W.

Each of the plurality of pins P is press-fit in a pin press-fit. hole. The pin press-fit hole is formed by the notched portions 37a provided on adjoining core splits 30 and facing each other.

Next, a direction nP of the normal of the seventh face (the pin press-fit surface) 37 of the stator 3 will be described using FIG. 6. FIG. 6 is a schematic diagram describing the direction nP of the normal of the seventh face (the pin press-fit surface) 37 of the stator 3.

FIG. 6 is a schematic diagram in which. the first face 31, the second face 32, and the seventh face (the pin press-fit surface) 37 are displayed being virtually overlapped with one another. In FIG. 6, out-of-plane directions of the first face 31 are indicated by first hatching (hatching by oblique lines from the upper right to the lower left), and the normal direction of the first face 31 is indicated by an arrow n1. Out-of-plane directions of the second face 32 are indicated by second hatching (hatching by oblique lines from the upper left to the lower right), and the normal direction of the second face 32 is indicated by an arrow n2. Further, the normal direction of the seventh face (the pin press-fit surface) 37 is indicated by an arrow nP. Directions that are the out-of- plane directions of the first face 31 and are also the out-of- plane directions of the second face 32 are indicated by hatching obtained by overlapping both of the first hatching and the second hatching (cross hatching).

As shown in FIG. 6, the direction nP of the normal of the seventh face (the pin press-fit surface) 37 is oriented in the out-of-plane direction of the first face 31 and is also oriented in the out-of-plane direction of the second face 32. Further, the direction nP of the normal of the seventh face (the pin press-fit surface) 37 is oriented in a direction between the direction n1 of the normal of the first face 31 and the direction n2 of the normal of the second face 32.

Thus, the plurality of core splits 30 are mutually split by the split surfaces 300 each of which is configured with the four or more constituent faces 31, 32, 33, 34, 35, 36, 37, and 38 extending along the axial direction, including three faces of the first face 31 closest to the magnetic gap portion G, the second face 32 next closest to the magnetic gap portion G after the first face 31, and the eighth face (the farthest face) 38 farthest from the magnetic gap portion G. The seventh face (the pin press-fit surface) 37 is one of constituent faces other than the first face 31 and the second face 32 and is a face the normal direction nP of which is oriented in the out-of-plane direction of the first face 31 or the out-of- plane direction of the second face 32. The plurality of pins P are press-fit pin press-fit holes, each of which is formed by the notched portions 37a provided on adjoining core splits 30 and facing each other.

According to the stator 3 as above, since the direction nP of the normal of the seventh face (the pin press-fit surface) 37 is oriented in the out-of-plane direction of the first face 31 or the out-of-plane direction of the second face 32, it is possible to cause the first faces 31 or the second faces 32 of adjoining core splits 30, which are close from the magnetic gap portion G, to be in close contact with each other. Thereby, it is possible to reduce cogging or ripple due to a gap between core splits 30. Further, it is possible to accurately assemble the core splits 30.

Further, in the stator 3, it is favorable that the seventh face (the pin press-fit surface) 37 is a constituent face other than the eighth face (the farthest face) 38, and that the direction nP of the normal is oriented in the direction between the direction n1 of the normal of the first face 31 and the direction n2 of the normal of the second face 32.

According to the stator 3 as above, since the direction nP of the normal of the seventh face (the pin press-fit surface) 37 is oriented in the direction between the direction n1 of the normal of the first face 31 and the direction n2 of the normal of the second face 32, it is possible to cause the mutual first faces 31 and the mutual second faces 32 of adjoining core splits 30, which are close from the magnetic gap portion G, to be in close contact with each other. Thereby, it is possible to further reduce cogging or ripple due to a gap between core splits 30. Further, it is possible to more accurately assemble the core splits 30.

Further, it is favorable that, between adjoining core splits 30 of the stator 3, the mutually facing eighth faces (the farthest faces) 38 are fixed by the welding W.

According to the stator 3 as above, since the facing eighth faces (the farthest faces) 38 of adjoining core splits 30 are fixed by the welding W, it is possible to increase stiffness.

[Fourth embodiment]

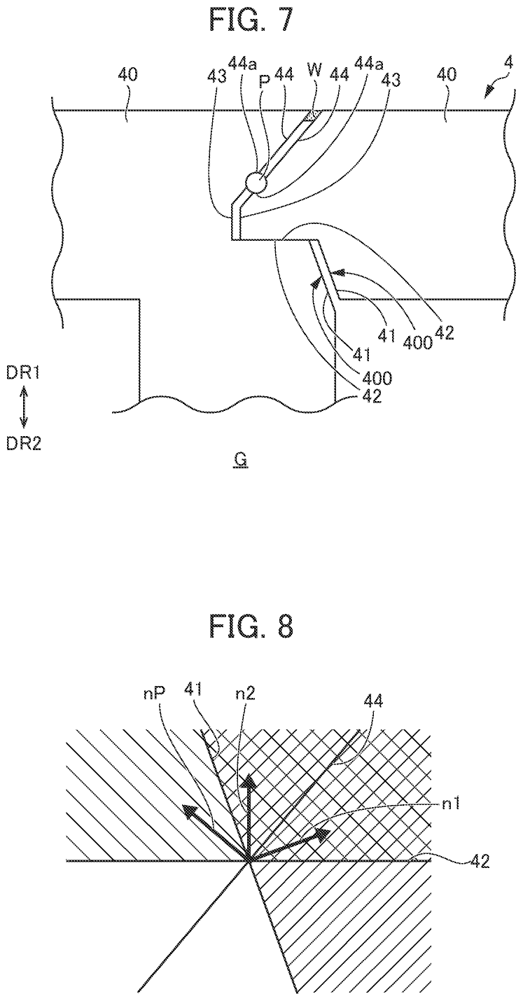

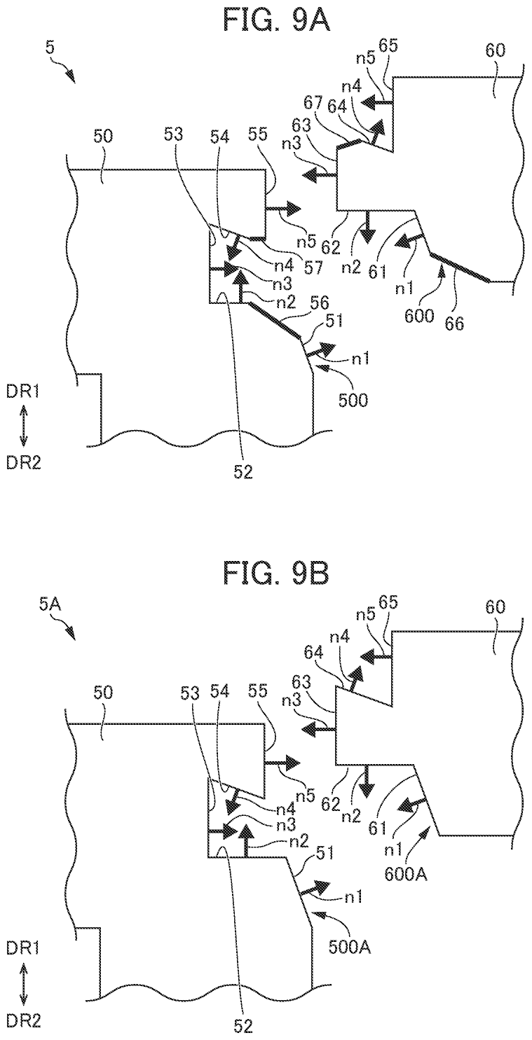

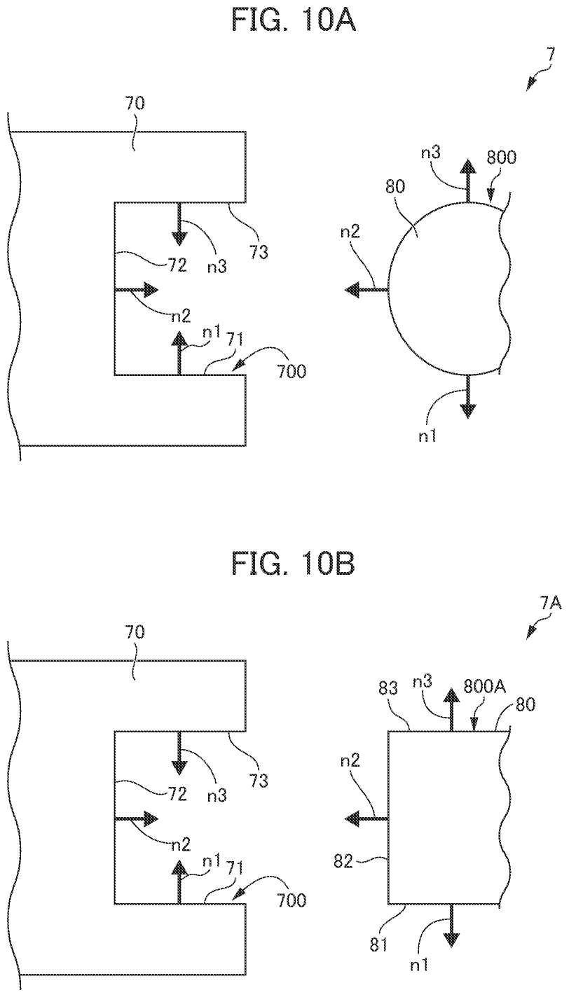

Next, configurations of a stator 4 and an electric motor (reference sign omitted.) according to a fourth embodiment will be described using FIG. 7. FIG. 7 is a cross-sectional diagram showing a part of the stator 4.

The stator 4 shown in FIG. 7 constitutes the electric motor (reference sign omitted) together with a rotor (not shown) arranged on a radial-direction inner side DR2 of the stator 4 (the lower side in FIG. 7). Specifically, the stator 4 is provided with a plurality of core splits 40, a plurality of pins P, a plurality of coils (not shown), and the like.

The plurality of core splits 40 are mutually split by split surfaces 400 extending along the axial direction (a direction penetrating the page of FIG. 7) and facing each other. The plurality of core splits 40 have a structure of being fit by being mutually slid in the axial direction.

Each split surface 400 is configured with four constituent laces 41, 42, 43, and 44 extending along the axial direction. The first face 41, which is a first constituent face, is closest to a magnetic gap portion G (on the radial- direction inner side DR2) which is a gap between the stator 4 and the rotor (not shown). The second face 42, which is a second constituent face, is a face continuous with the first face 41 and is next closest to the magnetic gap portion G after the first face 41. The third face 43, which is a third constituent face, is a face continuous with the second face 42 and is next closest to the magnetic gap portion P after the second face 42. The fourth face 44, which is a fourth constituent face, is a face continuous with the third face 43 and constitutes the farthest face farthest from the magnetic gap portion G. This fourth face 44 constitutes a pin press-fit surface where a notched portion 44a with an approximately semicircular-shaped section extending along the axial direction is provided. The notched portions 44a provided on adjoining core splits 40 and facing each other constitute a pin press-fit hole with an approximately circular-shaped (unclosed circular-shaped) section extending along the axial direction.

Between adjoining core splits 40, the facing fourth faces (the farthest faces) 44 are fixed by welding W.

Each of the plurality of pins P is press-fit in a pin press-fit hole. The pin press-fit hole is formed by the notched portions 44a provided on adjoining core splits 40 and facing each other.

Next, a direction nP of the normal of the fourth face (the pin press-fit surface) 44 of the stator 4 will be described using FIG. 8. FIG. 8 is a schematic diagram describing the direction nP of the normal of the fourth face (the pin press-fit surface) 44 of the stator 4.

FIG. 8 is a schematic diagram in which the first face 41, the second face 42, and the fourth face (the pin press-fit surface) 44 are displayed being virtually overlapped with one another. In FIG. 8, out-of-plane directions of the first face 41 are indicated by first hatching (hatching by oblique lines from the upper right to the lower left), and the normal direction of the first face 41 is indicated by an arrow n1. Out-of-plane directions of the second face 42 are indicated by second hatching (hatching by oblique lines from the upper left to the lower right), and the normal direction of the second face 42 is indicated by an arrow n2. Further, the normal direction of the fourth face (the pin press-fit surface) 44 is indicated by an arrow nP. Directions that are the out-of-plane directions of the first face 41 and are also the out-of-plane directions of the second face 42 are indicated by hatching obtained by overlapping both of the first hatching and the second hatching (cross hatching).

As shown in FIG. 8, the direction nP of the normal of the fourth face (the pin press-fit surface) 14 is oriented in the out-of-plane direction of the second face 42.

Thus, the plurality of core splits 40 are mutually split by the split surfaces 400 each of which is configured with the four or more constituent faces 41, 42, 43, and 44 extending along the axial direction, including three faces of the first face 41 closest to the magnetic gap portion G, the second face 42 next closest to the magnetic gap portion G after the first face 41, and the fourth face (the farthest face) 44 farthest from the magnetic gap portion G. The fourth face (the pin press-fit surface) 44 is one of constituent faces other than the first face 41 and the second face 42 and is a face the normal direction nP of which is oriented in the out-of-plane direction of the second face 42. The plurality of pins P are press-fit in pin press-fit holes, each of which is formed by the notched portions 44a provided on adjoining core splits 40 and facing each other.

According to the stator 4 as above, since the direction nP of the normal of the fourth face (the pin press-fit surface) 44 is oriented in the out-of-plane direction of the second face 42, it is possible to cause the second faces 42 of adjoining core splits 40, which are close from the magnetic gap portion G, to be in close contact with each other. Thereby, it is possible to reduce cogging or ripple due to a gap between core splits 40. Further, it is possible to accurately assemble the core splits 40.

Further, it is favorable that, between adjoining core splits 40 of the stator 4, the facing fourth. faces (the farthest faces) 44 are fixed by the welding W.

According to the stator 4 as above, since the facing fourth faces (the farthest faces) 44 of adjoining core splits 40 are fixed by the welding W, it is possible to increase stiffness.

[The number of constituent faces constituting split surface (1)]

Next, the number of constituent faces constituting each of split surfaces 500 and 600 of adjoining core splits 50 and 60 will be described using FIGS. 9A and 9B. How to count the number of constituent faces described here is applied to each of the above embodiments. FIG. 9A is a diagram for illustrating the number of constituent faces constituting each of the split surfaces 500 and 600 and is an exploded cross- sectional view showing a part of a stator 5. FIG. 9B is an exploded cross-sectional view showing a part of a stator 5A equivalent to the stator 5.

The adjoining core splits 50 and 60 are mutually split by the split surfaces 500 and 600 extending along the axial direction (a direction penetrating the page of FIG. 9A) and facing each other. The adjoining core splits 50 and 60 have a structure of being fit by being mutually slid in the axial direction.

The split surface 500 is configured with five constituent faces 51, 52, 53, 54, and 55 and two chamfered faces 56 and 57 extending along the axial direction. For the first face 51, which is a first constituent face, the normal direction is indicated by an arrow n1. The chamfered face 56, which is a first chamfered face, is a face continuous with the first face 51. The second face 52, which is a second constituent face, is a face continuous with the chamfered face 56, and the normal direction is indicated by an arrow n2. The third face 53, which is a third constituent face, is a face continuous with the second face 52, and the normal direction is indicated by an arrow n3. The fourth face 54, which is a fourth constituent face, is a face continuous with the third face 53, and the normal direction is indicated by an arrow n4. The chamfered face 57, which is a second chamfered face, is a face continuous with the fourth face. The fifth face 55, which is a fifth constituent face, is a face continuous with the chamfered face 57, and the normal direction is indicated by an arrow n5.

The split surface 600 is configured with five constituent faces 61, 62, 63, 64, and 65 and two chamfered faces 66 and 67 extending along the axial direction. The first face 61, which is a first constituent face, is a face continuous with the chamfered face 66, which is a first chamfered face, and the normal direction is indicated by an arrow n1. The second face 62, which is a second constituent face, is a face continuous with the first face 61, and the normal direction is indicated by an arrow n2. The third face 63, which is a third constituent face, is a face continuous with the second face 62, and the normal direction is indicated by an arrow n3. The chamfered face 67, which is a second chamfered face, is a face continuous with the third face 63. The fourth face 64, which is a fourth constituent face, is a face continuous with the chamfered face 67, and the normal direction is indicated by an arrow n4. The fifth face 65, which is a fifth constituent face, is a face continuous with the fourth face 64, and the normal direction is indicated by an arrow n5.

That is, the first face 51 of the split surface 500 and the first face 61 of the split surface 600 have corresponding normals in the direction n1 and are counted as corresponding constituent faces. The second face 52 of the split surface 500 and the second face 62 of the split surface 600 have corresponding normals in the direction n2 and are counted as corresponding constituent faces. The third face 53 of the split surface 500 and the third face 63 of the split surface 600 have corresponding normals in the direction n3 and are counted as corresponding constituent faces. The fourth face 54 of the split surface 500 and the fourth face 64 of the split surface 600 have corresponding normals in the direction n4 and are counted as corresponding constituent faces. The fifth face 55 of the split surface 500 and the fifth face 65 of the split surface 600 have corresponding normals in the direction n5 and are counted as corresponding constituent faces. On the other hand, the chamfered faces 56 and 57 of the split surface 500 and the chamfered faces 66 and 67 of the split surface 600 do not have corresponding normals, and are not counted as constituent faces.

From the above, the stator 5 shown in FIG. 9A is equivalent to the stator 5A shown in FIG. 9B. As shown in FIG. 9B, the stator 5A is different from the stator 5 in that the split surface 500A instead of the split surface 500 has neither the chamfered face 56 nor 57, and the split surface 600A instead of the split surface 600 has neither the chamfered face 66 nor 67. Other components of the stator 5A are equal to those of the stator 5. The same components are given the same reference signs as those of the stator 5, and description thereof will be omitted.

[The number of constituent faces constituting split surface (2)]

Next, the number of constituent faces constituting each of split surfaces 700 and 800 of adjoining core splits 70 and 80 will be described using FIGS. 10A and 10B. How to count the number of constituent faces described here is applied to each of the above embodiments. FIG. 10A is an exploded cross- sectional view showing a part of a stator 7, which illustrates the number of constituent faces constituting each of split surfaces 700 and 800. FIG. 10B is an exploded cross-sectional view showing a part of a stator 7A. equivalent to the stator 7.

The adjoining core splits 70 and 80 are mutually split by the split surfaces 700 and 800 extending along the axial direction (a direction penetrating the page of FIG. 10A) and facing each other. The adjoining core splits 70 and 80 have a structure of being fit by being mutually slid in the axial direction.

Each split surface 700 includes three constituent faces 71, 72, and 73 extending along the axial direction. For the first face 71, which is a first constituent face, the normal direction is indicated by an arrow nl. The second face 72, which is a second constituent face, is a face continuous with the first face 71, and the normal direction is indicated by an arrow n2. The third face 73, which is a third constituent face, is a face continuous with the second face 72, and the normal direction is indicated by an arrow n3.

Each split surface 000 is a curved surface extending along the ax axial direction. The split surface 800 has countless directions including directions indicated by the arrows n1, n2 and n3.

That is, the first face 71 of the split surface 700 and the split surface 800 have corresponding normals in the direction n1 and are counted as corresponding constituent faces. The second face 72 of the split surface 700 and the split surface 800 have corresponding normals in the direction n2 and are counted as corresponding constituent faces. The third face 73 of the split surface 700 and the split surface 800 have corresponding normals in the direction n3 and are counted as corresponding constituent faces.

Thus, the stator 7 shown in FIG. 10A is equivalent to the stator 7A shown in FIG. 10B. As shown in FIG. 10B, the stator 7A is different from the stator 7 in that a split surface 800A instead of the split surface 800 includes three constituent faces 81, 82, and 83 along the axial direction. For the first face 81, which is a first consttuent face, the normal direction is indicated by an arrow n1. The second face 82, which is a second constituent face, is a face continuous with the first face 81, and the normal direction is indicated by an arrow n2. The third face 83, which is a third constituent face, is a face continuous with the second face 82, and the normal direction is indicated by an arrow n3. Other components of the stator 7A are equal to those of the stator 7. The same components are given the same reference signs as those of the stator 7, and description thereof will be omitted.

The present invention is not limited to the above embodiments, and various changes and modifications are possible.

For example, though description has been made on the example in which the notched portion 44a is provided on the fourth face 44 in the fourth embodiment shown in FIG. 7, the present invention is not limited thereto. A notched portion may be provided on the third face 43. In this case, since the direction nP of the normal of the third face (the pin press- fit surface) 43 is oriented in the out-of-plane direction of the first face 41, it is possible to cause the first faces 41 of adjoining core splits 40, which are close from the magnetic gap portion G, to be in close contact with each other. A rotating electrical machine of the present invention is not limited to an electric motor but may be a power generator.

### EXPLANATION OF REFERENCE NUMERALS

1, 3, 4, 5, 5A, 7, 7A Stator

2 Rotor

10, 20, 30, 40, 50, 60, 70, 80 Core split

11, 21, 31, 41, 51, 61, 71, 81 First face (constituent face)

12, 22, 32, 42, 52, 62, 72, 82 Second face (constituent face)

13, 23, 33, 43, 53, 63 Third face (constituent face)

73, 83 Third face (constituent face, farthest face)

14, 24 Fourth face (constituent face, pin press-fit surface)

34, 54, 64 Fourth face (constituent face)

44 Fourth face (constituent face, pin press-fit surface, farthest face)

15, 25, 55, 65 Fifth face (constituent face, farthest face)

35 Fifth face (constituent face)

36 Sixth face (constituent face)

37 Seventh face (constituent face, pin press-fit surface)

38 Eighth face (constituent face, farthest face)

56, 57, 66, 67 Chamfered face

14a, 24a, 37a, 44a Notched portion (pin press-fit hole)

100, 200, 300, 400, 500, 500A, 600, 600A, 700, 800, 800A Split surface

P Pin

G Magnetic gap portion

W Welding

n1 Normal direction of first face

n2 Normal direction of second face

n3 Normal direction of third face

n4 Normal direction of fourth face

n5 Normal direction of fifth face

nP Normal direction of pin press-fit surface

1. A stator comprising:
a plurality of core splits, each of the core splits having a notched portion extending along an axial direction; and
a plurality of pins press-fit in pin press-fit holes, each of the pin press-fit holes being formed by notched portions provided on adjoining core splits and facing each other, wherein
the plurality of core splits are mutually split by split surfaces, each of the split surfaces being configured with four or more constituent faces extending along the axial direction, the constituent faces including three faces of a first face closest to a magnetic gap portion, a second face next closest to the magnetic gap portion after the first face, and a farthest face farthest from the magnetic gap portion, and
a pin press-fit surface that is one of the constituent faces other than the first face and the second face and provided with the notched portion has a normal direction oriented in an out-of-plane direction of the first face or an out-of-plane direction of the second face.

2. The stator according to claim 1, wherein the pin press-fit surface is a constituent face other than the farthest face, and the normal direction is oriented in a direction between a normal direction of the first face and a normal direction of the second face.

3. The stator according to claim 1, wherein between the adjoining core splits, the facing farthest faces are fixed by welding.

4. A rotating electrical machine comprising:
the stator according to claim 1; and
a rotor arranged at an inner side of the stator.

5. A rotor comprising:
a plurality of core splits, each of the core splits having a notched portion extending along an axial direction; and
a plurality of pins press-fit in pin press-fit holes, each of the pin press-fit holes being formed by notched portions provided on adjoining core splits and facing each other, wherein
the plurality of core splits are mutually split by split surfaces, each of the split surfaces being configured with four or more constituent faces extending along the axial direction, the constituent faces including three faces of a first face closest to a magnetic gap portion, a second face next closest to the magnetic gap portion after the first face, and a farthest face farthest from the magnetic gap portion, and
a pin press-fit surface that is one of the constituent faces other than the first face and the second face and provided with the notched portion has a normal direction oriented in an out-of-plane direction of the first face or an out-of-plane direction of the second face.

6. The rotor according to claim 5, wherein the pin press-fit surface is a constituent face other than the farthest face, and the normal direction is oriented in a direction between a normal direction of the first face and a normal direction of the second face.

7. A rotating electrical machine comprising:
a rotor according to claim 5; and
a stator arranged at an outer side of the rotor.
